(19) United States
(12) Patent Application Publication
(10) Pub. No.: US 2014/0191638 A1
(43) Pub. Date: Jul. 10, 2014

(54) ELECTRONIC DEVICE

(71) Applicant: NEC CASIO MOBILE COMMUNICATIONS, LTD., Kanagawa (JP)

(72) Inventors: Junichi NAKAO, Kawasaki-shi (JP); Shinobu HOSONO, Kawasaki-shi (JP)

(73) Assignee: NEC CASIO MOBILE COMMUNICATIONS, LTD., Kanagawa (JP)

(21) Appl. No.: 13/737,468

(22) Filed: Jan. 9, 2013

(51) Int. Cl. H04M 1/02

(52) U.S. Cl. CPC H04M 1/0206; H04M 1/026
USPC 312/229

(57) ABSTRACT

Electronic device includes main body, cover having through hole and covering at least part of main body, fixing mechanism fixing cover to main body, and waterproof mechanism draining water to outside, water having entered into gap between cover and main body. Fixing mechanism includes rotating knob provided in main body and inserted into through hole when cover is fixed to main body, protruding portion moved by rotation of rotating knob, engaging portion provided inside cover and engaging with protruding portion when cover is fixed to main body, and recess portion provided in main body and accommodating engaging portion when cover is fixed to main body. Waterproof mechanism includes groove portion provided in main body or cover, extending toward outer edge direction of cover, and coming into communication with recess portion when cover is fixed to main body.

### REFERENCE TO RELATED APPLICATION

This application is based upon an earlier Japanese patent application No. 2010-281471, filed on Dec. 17, 2010, now laid-open as JP Kokai Publication No. JP2012-129441A on Jul. 5, 2012, the disclosure of which is incorporated herein in its entirety by reference thereto.

### TECHNICAL FIELD

The present disclosure relates to an electronic device having a waterproof mechanism.

### BACKGROUND

Portable electronic devices such as mobile phones are equipped with a detachable cover so that a battery can be changed. However, if water enters through a gap between a cover and the housing of such portable electronic device, a malfunction or a short circuit is caused. In response, conventional electronic devices include a waterproof mechanism for preventing water from entering into a battery storage space or the like (see Patent Literatures (PTLs) 1 and 2, for example).

In an electronic device disclosed in PTL 1, a storage chamber is formed by coupling two housing members with each other, a groove that extends around the storage chamber being provided in one of the joint surfaces of these two housing members, a space based on the groove being formed between the bottom surface of the groove of one joint surface and the other joint surface in a state in which two housing members are coupled with each other.

According to a waterproof housing structure disclosed in PTL 2, a cover is detachably attached to a cover attachment portion of a housing, and a groove portion is provided around the cover attachment portion of the housing, so that water or the like, which has entered through a gap between the cover and the cover attachment portion, is drained through the groove portion.

### [PTL 1]

Japanese Patent Kokai Publication No. JP2010-226531A

### [PTL 2]

Japanese Patent Kokai Publication No. JP-H08-8546A

### SUMMARY

The following analyses are given from a viewpoint of the present disclosure.

For example, a portable electronic device having a cover for storing a battery or the like is provided with a mechanically movable fixing mechanism, to prevent detachment of the cover while carried and to detachably fix the cover. The fixing mechanism has a mechanism so that a user operates a movable portion of the fixing mechanism to fix/detach the cover to/from the main body. Thus, there are some cases where the installation of the fixing mechanism forms a gap in the cover, the inside and outside of the cover communicating by the gap. This gap can serve as a flow path of water entering into the inside of the cover. Therefore, a waterproof mechanism is necessary to facilitate drain of water, which has entered into a space between the cover and the main body, to the outside.

The waterproof mechanisms disclosed in PTLs 1 and 2 are for preventing water from entering from the periphery of the cover into the inside of the cover. Thus, once water enters into the inside of the cover, the water cannot be drained. If water remains inside the cover, for example, even if the battery storage space is waterproofed by packing that is arranged inside the cover, the packing is also detached from the main body when the cover is detached. As a result, the water remaining inside the cover flows into the battery storage space. In addition, the waterproof mechanisms disclosed in PTLs 1 and 2 cannot prevent water from entering from the fixing mechanism.

According to a first aspect of the present disclosure, an electronic device comprises a main body, a cover having a through hole and covering at least part of the main body, a fixing mechanism fixing the cover to the main body, and a waterproof mechanism draining water to the outside, the water having entered into a gap between the cover and the main body. The fixing mechanism includes a rotating knob provided in the main body and inserted into the through hole when the cover is fixed to the main body, a protruding portion moved by rotation of the rotating knob, an engaging portion provided inside of the cover and engaging with the protruding portion when the cover is fixed to the main body, and a recess portion provided in the main body and accommodating the engaging portion when the cover is fixed to the main body. The waterproof mechanism includes a groove portion provided in the main body or the cover, extending toward an outer edge of the cover, and coming into communication with the recess portion when the cover is fixed to the main body.

The meritorious effects of the present disclosure are summarized as follows. Even when water enters into space between the cover and the main body, the water can be drained to the outside through the groove portion. Particularly, by causing a water entrance portion and the groove portion to be in communication with each other, water can be prevented from remaining inside the cover. In this way, when the cover is opened, water that has remained inside the cover is prevented from flowing to a protected portion.

### BRIEF DESCRIPTION OF THE DRAWINGS

FIG. 1 is a schematic plan view of an electronic device according to a first exemplary embodiment of the present disclosure.

FIG. 2 is a schematic perspective view of the electronic device illustrated in FIG. 1.

FIG. 3 is a schematic plan view of the electronic device illustrated in FIG. 1, with a cover detached.

FIG. 4 is a schematic enlarged view of a fixing mechanism and a waterproof mechanism illustrated in FIG. 3.

FIG. 5 is a schematic perspective view of a housing of a main body.

FIG. 6 is a schematic plan view of a part of the electronic device according to the first exemplary embodiment of the present disclosure.

FIG. 7 is a schematic sectional view taken along a line VII-VII in FIG. 6.

FIG. 8 is a schematic plan view of the cover.

FIG. 9 is a schematic sectional view taken along a line IX-IX in FIG. 8.

FIG. 10 is a schematic enlarged view of a portion X in FIG. 9.

FIG. 11 is a schematic sectional view illustrating an example of a state where a water stop portion and a contact portion are in contact with each other.

### PREFERRED MODES

Preferred modes of the above first aspect will be described below.

According to a preferred mode of the first aspect, the main body further includes a protected portion (portion to be protected) exposed from the main body when the cover is detached. A waterproof mechanism further includes a water stop portion that is provided between the cover and the main body and that prevents water from entering into the protected portion when the cover is fixed to the main body. A groove portion is formed close to the water stop portion with respect to the rotating knob.

According to a preferred mode of the first aspect, the groove portion extends along part of the water stop portion.

According to a preferred mode of the first aspect, a recess portion further accommodates a protruding portion disengaged from the engaging portion when a rotating knob is rotated to detach the cover from the main body.

According to a preferred mode of the first aspect, part of the water that has entered into a gap between the cover and the main body is drained to the outside through the groove portion by shaking the electronic device by an operator.

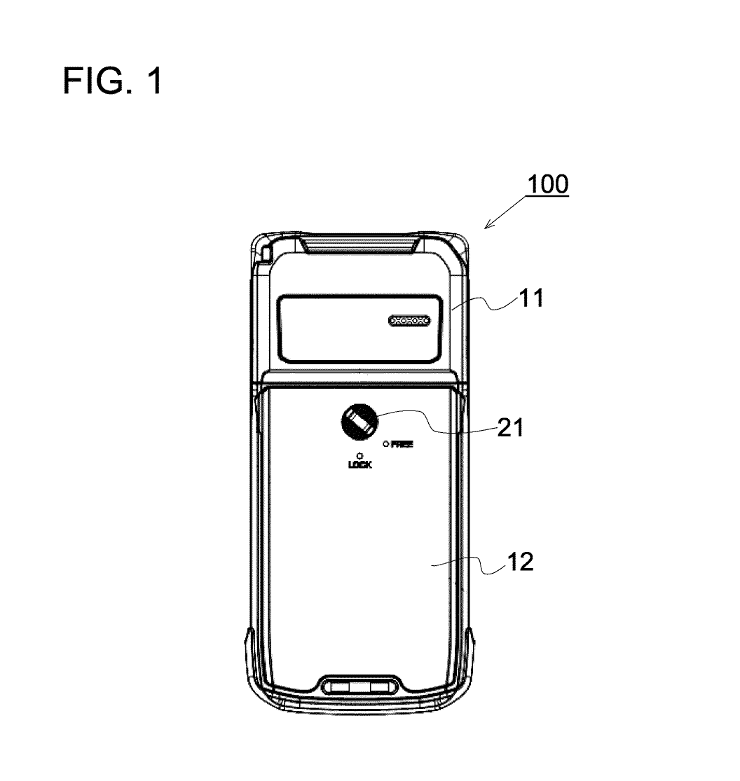

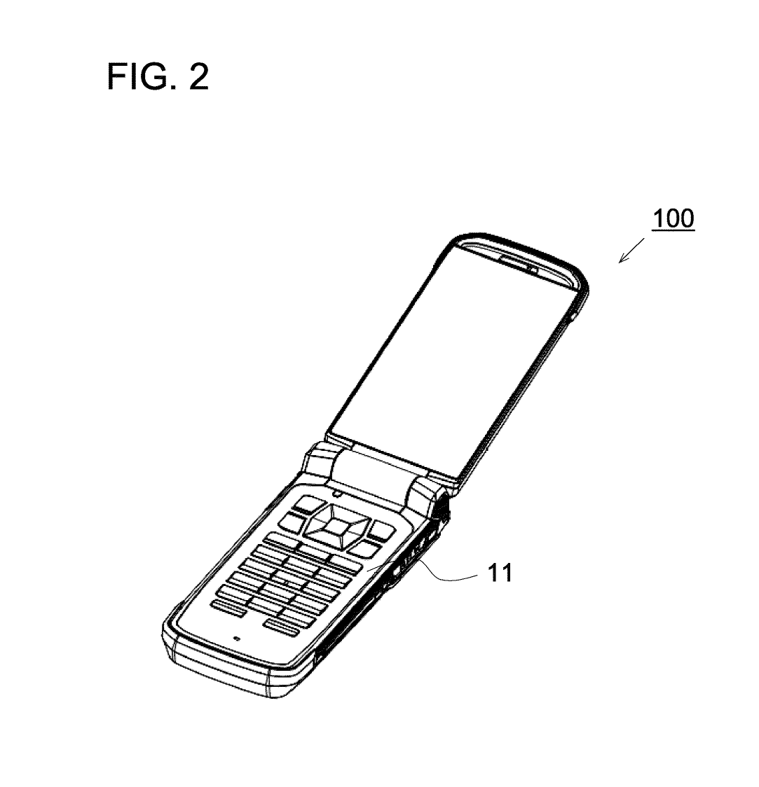

An electronic device according to a first exemplary embodiment of the present disclosure will be described. A mobile phone will be described as an example of the electronic device. FIG. 1 illustrates a schematic plan view of an electronic device according to a first exemplary embodiment of the present disclosure. FIG. 2 illustrates a schematic perspective view of the electronic device illustrated in FIG. 1. An electronic device 100 illustrated in FIGS. 1 and 2 is a foldable mobile phone. FIG. 1 is a plan view from a cover 12 side in a folded (closed) state. FIG. 2 is a perspective view from a display and key button side in a unfolded (opened) state.

The electronic device 100 comprises a main body 11, a cover 12 detachably attached to the main body 11, a fixing mechanism 20 to fix the cover 12 to the main body 11, and a waterproof mechanism to drain water to the outside when the water enters from the fixing mechanism 20 into the inside. For example, the cover 12 is provided to cover a battery storage space, so that a battery (including a rechargeable battery) can be replaced. The cover 12 is not limited to a cover for the battery storage portion, and may be provided at an arbitrary position corresponding to a portion opened/closed by an operator (for example, an earphone jack, a connector portion, and a card slot). The cover 12 may be a part of a housing of the electronic device 100, for example.

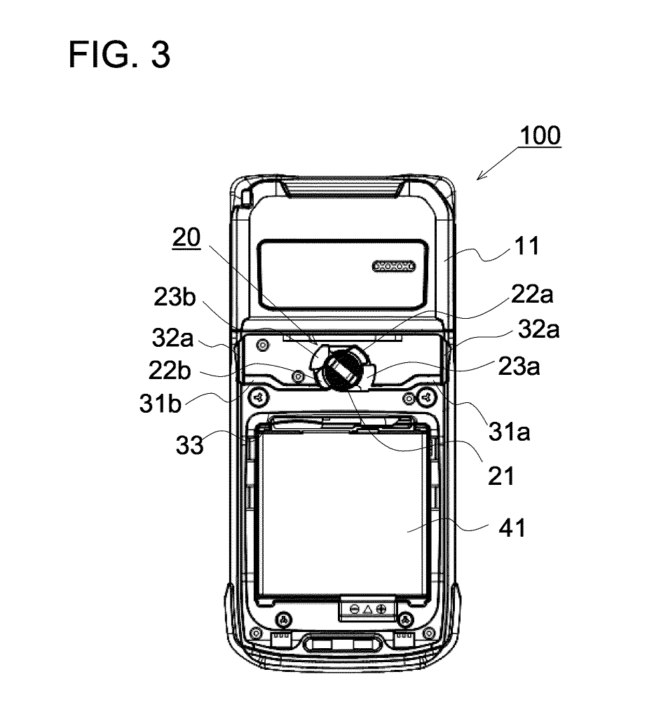

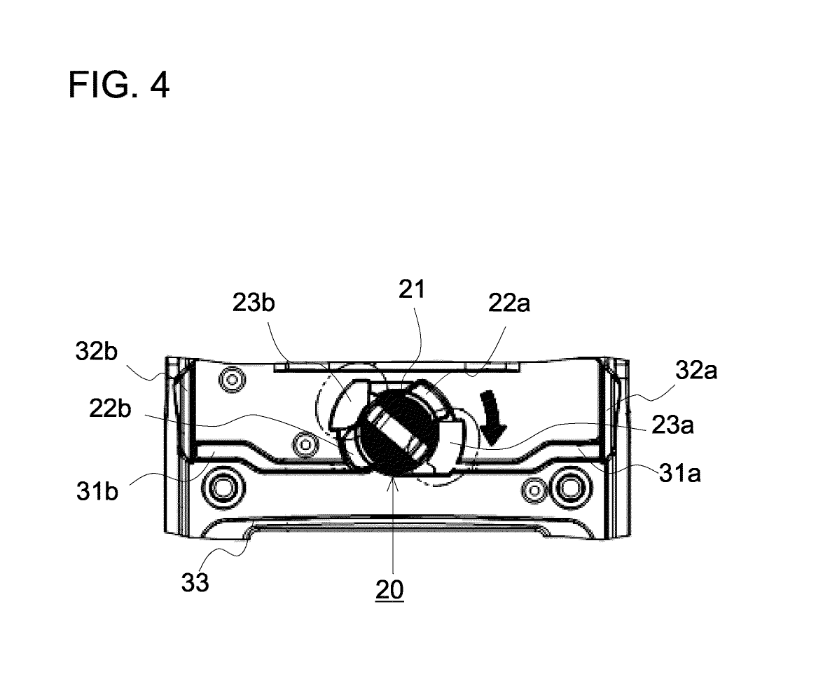

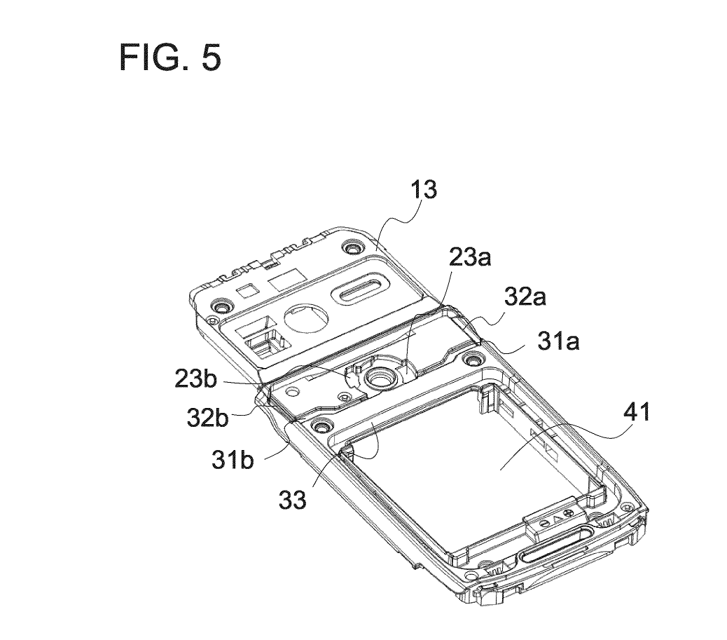

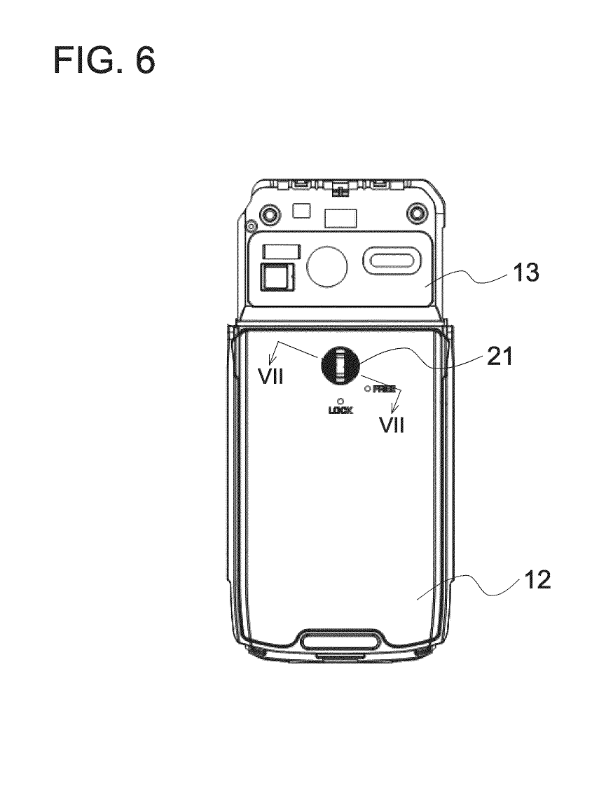

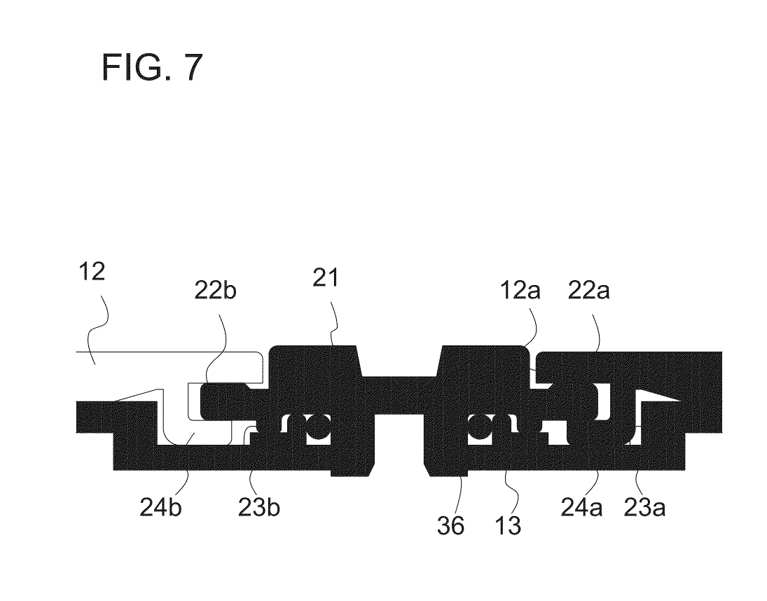

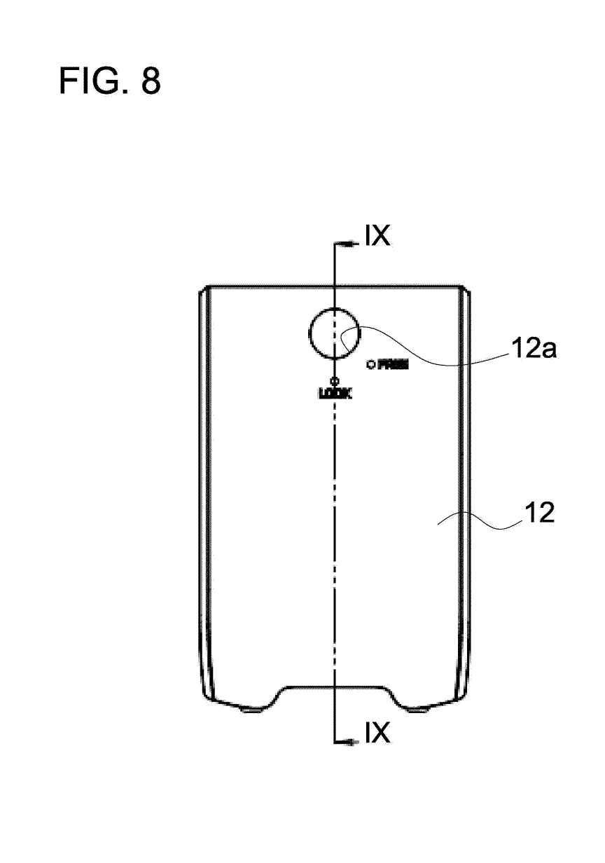

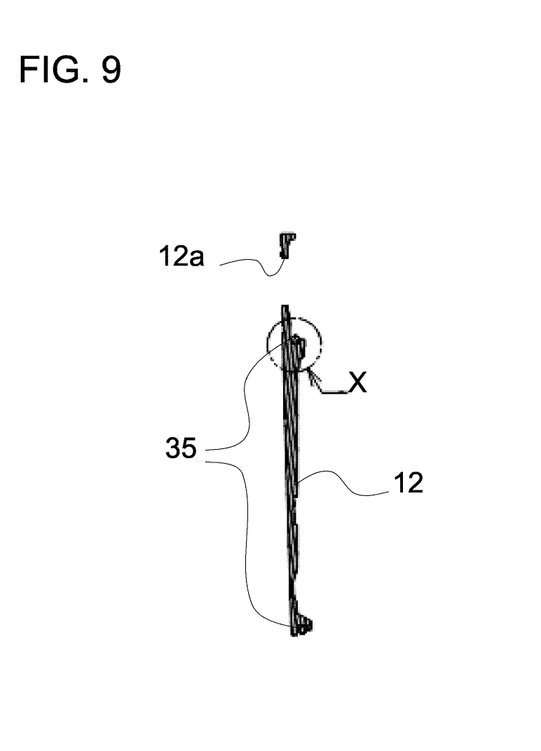

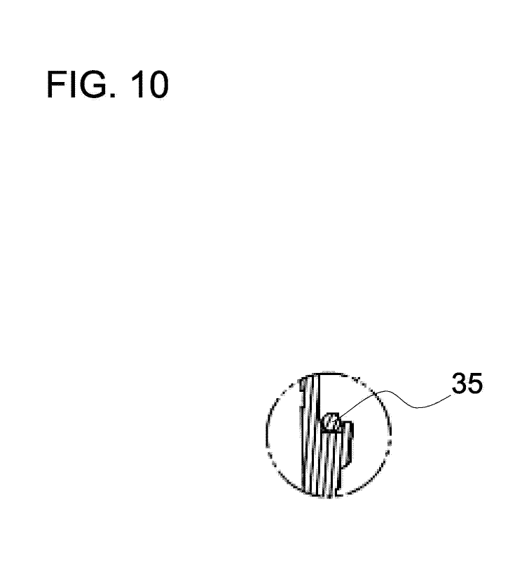

FIG. 3 illustrates a schematic plan view of the electronic device 100 illustrated in FIG. 1, with the cover 12 detached. Namely, FIG. 3 illustrates a schematic plan view of the main body inside the cover 12. FIG. 4 illustrates a schematic enlarged view of the fixing mechanism and the waterproof mechanism illustrated in FIG. 3. FIG. 5 illustrates a schematic perspective view of the housing of the main body on which the fixing mechanism and the waterproof mechanism are formed. FIG. 6 illustrates a schematic plan view of a part of the electronic device according to the first exemplary embodiment of the present disclosure. FIG. 7 illustrates a schematic sectional view taken along Line VII-VII in FIG. 6. FIG. 7 illustrates a state where the cover 12 is fixed to the main body 11. FIG. 8 illustrates a schematic plan view of the cover. FIG. 9 illustrates a schematic sectional view taken along Line IX-IX in FIG. 8. FIG. 10 is a schematic enlarged view of Portion X in FIG. 9.

The fixing mechanism 20 illustrated in FIGS. 1 to 7 will be described. The fixing mechanism 20 includes a rotating knob 21 (not illustrated in FIG. 5) attached to the housing 13 of the main body 11, and protruding portions 22a and 22b that are attached to the rotating knob 21 and that move by rotation of the rotating knob 21. These protruding portions 22a and 22b may be formed integrally with the rotating knob 21, as illustrated in FIG. 7. In addition, on the cover 12, the fixing mechanism 20 includes a through hole 12a, into which the rotating knob 21 is inserted, for causing a part of the rotating knob 21 to expose to the outside, and engaging portions 24a and 24b engaging with the protruding portions 22a and 22b when the cover 12 is fixed to the main body 11.

The waterproof mechanism includes recess portions 23a and 23b in which the engaging portions 24a and 24b are accommodated or fitted when the cover 12 is attached to the main body 11, groove portions 31a and 31b that are in communication with the recess portions 23a and 23b and that extend toward edge portions of the cover 12 (toward the side portions of the main body 11 in FIGS. 3 and 4), and drain portions 32a and 32b that are located on edge portions of the groove portions 31a and 31b (on sides of the main body 11) and that are in communication with the groove portions 31a and 31b for draining away water to the outside. Since the recess portions 23a and 23b are formed to be in communication with the groove portions 31a and 31b, respectively, water that has entered into the recess portions 23a and 23b via the through hole 12a can be guided to the drain portions 32a and 32b via the groove portions 31a and 31b. The recess portions 23a and 23b are formed outside the rotating knob 21 and extend along part of the circumference of the rotating knob 21 in the circumferential direction. The recess portions 23a and 23b may accommodate not only the engaging portions but also the protruding portions 22a and 22b released from the engaging portions by rotation of the rotating knob 21. In the mode illustrated in FIG. 5, the regions accommodating the engaging portions 24a and 24b in the recess portions 23a and 23b are made lower than other portions. In the mode illustrated in FIGS. 3, 4, and 7, based on the positions of and the number of the engaging portions, two recess portions 23a and 23b are formed so as to face each other across a diameter of the rotating knob 21. In the mode illustrated in FIGS. 3, 4, and 6, the groove portions 31a and 31b are formed on the housing 13 of the main body 11. However, alternatively, the groove portions 31a and 31b may be formed in the cover 12 so that, when the cover 12 is attached to the main body 11, a water guide path is formed by the cover 12 and the main body 11. In the mode illustrated in FIG. 7, a packing 36 is provided between the rotating knob 21 and the housing 13, to prevent water from entering into the housing 13 from a gap between the rotating knob 21 and the housing 13.

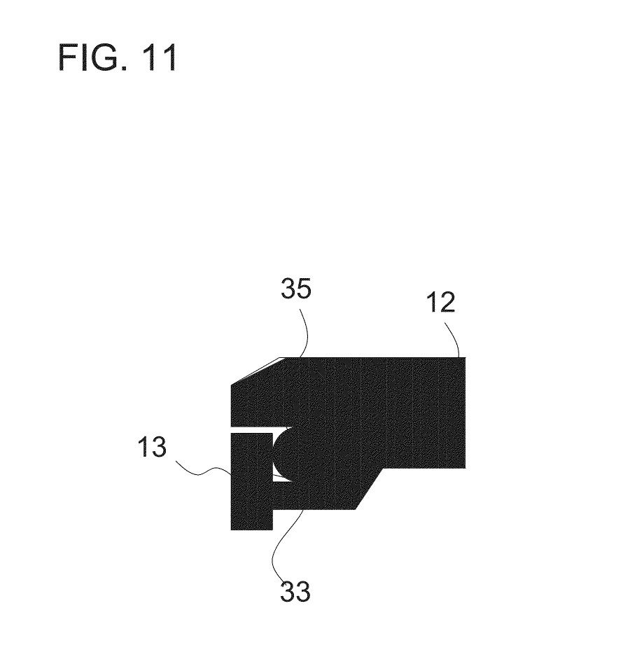

In addition, the waterproof mechanism is formed to surround a portion 41 that needs to be protected (which will be hereinafter referred to as a protected portion 41) such as a battery storage space. The waterproof mechanism includes a water stop portion 35 and contact portion 33 for preventing from water entering into the protected portion 41. FIG. 11 illustrates a schematic sectional view illustrating one example of a state where the water stop portion and the contact portion are in contact with each other. In the mode illustrated in FIGS. 9 to 11, by causing the water stop portion 35 and the contact portion 33 to come into contact with each other and to tightly attach to each other, water is prevented from entering into the protected portion 41. The water stop portion 35 is formed on the back side of the cover 12. For example, the contact portion 33 may be formed on a side of the battery storage space (on an inner wall of the opening). The water stop portion 35 is for preventing water that has entered into the gap between the main body 11 and the cover 12 from flowing further into the protected portion 41. For example, the water stop portion 35 may include an O-ring packing such as a silicon rubber for causing the main body 11 and the cover 12 to tightly attach to each other. In the mode illustrated in FIGS. 8 to 11, the water stop portion 35 is primarily formed on the inside of the cover 12. However, alternatively, the water stop portion 35 may be formed on the main body 11 and/or the cover 12. In addition, alternatively, the contact portion 33 may be formed on the cover 12 and/or the main body 11. The contact portion 33 may be formed as a protruding portion or a groove portion that comes into contact with and attaches to the water stop portion (the packing in the figures, for example) 35 around the protected portion 41 of the main body 11 when the cover 12 is attached to the main body 11. In this way, since no gap is formed between the cover 12 and the main body 11, water can be prevented from entering into the protected portion 41.

The groove portions 31a and 31b are formed outside the protected portion 41, namely, between an outer edge of the cover 12 and the water stop portion 35. It is preferred that the groove portions 31a and 31b extend along a part of the water stop portion 35. In the mode illustrated in FIGS. 3 to 5, the groove portions 31a and 31b extend approximately in parallel to a part of the water stop portion 35 that extends toward the side of the electronic device. It is preferred that the groove portions 31a and 31b be formed closer to the water stop portion 35 with respect to the rotating knob 21. For example, in the mode illustrated in FIGS. 3 and 4, the groove portions 31a and 31b are formed closer to the water stop portion 35 and the contact portion 33 from the center of the rotating knob 21 (on an underside in FIGS. 3 and 4). In this way, water blocked by the water stop portion 35 can easily be drained through the groove portions 31a and 31b. In the mode illustrated in FIGS. 3 to 5, the groove portions 31a and 31b extend to the right and left directions, respectively, from the rotating knob 21. However, alternatively, the groove portions 31a and 31b may extend only in one of the directions.

Next, an operation of the fixing mechanism 20 of the electronic device 100 according to the present disclosure illustrated in FIGS. 1 to 11 will be described. To fix the cover 12 to the main body 11, the operator inserts the rotating knob 21 into the through hole 12a. After attaching the cover 12 to the main body 11, the operator rotates the rotating knob 21. Consequently, for example, the blade-shaped protruding portions 22a and 22b are moved in the circumferential direction and are then engaged with the engaging portions 24a and 24b of the cover 12. Since the protruding portions 22a and 22b are engaged with the engaging portions 24a and 24b, the cover 12 is fixed to the main body 11. Namely, the cover 12 is locked. To detach the cover 12 from the main body 11, the operator rotates the rotating knob 21 in the reverse direction. Consequently, the protruding portions 22a and 22b are moved in the circumferential direction. As a result, since the protruding portions 22a and 22b are disengaged from the engaging portions 24a and 24b, the cover 12 can be detached from the main body 11.

In the mode illustrated in FIGS. 3, 4, and 7, two protruding portions 22a and 22b are formed on the rotating knob 21. These two protruding portions 22a and 22b protrude in a diametrical direction of the rotating knob 21. The engaging portions 24a and 24b are formed on the backside of the cover 12. In the mode illustrated in FIGS. 1 to 9, based on the positions and the number of the protruding portions 22a and 22b, two engaging portions 24a and 24b are formed.

Next, an operation of the waterproof mechanism of the electronic device 100 according to the present disclosure will be described. If the electronic device 100 gets wet or is dropped into water, water enters into the inside of the cover 12 through the gap between the through hole 12a of the cover 12 and the rotating knob 21 of the main body 11. If the operator shakes the electronic device 100 a few times to drain the water that has entered into the inside of the cover 12, centrifugal force is applied to the water. Because of this centrifugal force, the water inside the cover 12 is moved toward the edge of the cover 12 through the groove portions 31a and 31b. As a result, the water is drained through the gap between the outer edge of cover 12 and the main body 11 (namely, through the drain portions 32a and 32b). As illustrated in FIGS. 4 and 5, since the recess portions 23a and 23b are in communication with the groove portions 31a and 31b, water that exists in the gap between the through hole 12a and the rotating knob 21 or in the recess portions 23a and 23b can reach the groove portions 31a and 31b. Thus, no water remains between the cover 12 and the main body 11. In addition, if the groove portions 31a and 31b are formed so as to extend in the same direction as that of a part of the water stop portion 35 and are formed close to the water stop portion 35, water blocked by the water stop portion 35 also reaches the groove portions 31a and 31b easily. Thus, water is less likely to remain inside the cover 12. In addition, even if water exists between the main body 11 and the cover 12 in areas other than in the recess portions 23a and 23b and the groove portions 31a and 31b, the water can of course be drained by shaking the electronic device 100. However, since there are the groove portions 31a and 31b, the water can be guided to the drain portions 32a and 32b more easily.

In the above description, as an example, the protruding portions and the recess portions are formed on the main body and the engaging portions are formed on the cover. However, alternatively, the protruding portions and the recess portions may be formed on the cover and the engaging portions may be formed on the main body. In such case, as long as the groove portions are formed in communication with the recess portions when the cover is closed, the groove portions may be formed on the main body or the cover.

The above description has been made based on an example where water enters through the fixing mechanism. However, the present disclosure is applicable to other cases where water enters through portions other than the fixing mechanism.

While the electronic device according to the present disclosure has thus been described based on the above exemplary embodiment, the present disclosure is not limited thereto. It is needless to say that various variations, changes, and modifications can be made to the above exemplary embodiment within the scope of the present disclosure and based on the basic technical concept thereof. In addition, various combinations, substitutions, and selections of various disclosed elements are possible within the scope of the claims of the present disclosure.

Further problems, purposes, and extended modes of the present disclosure will be apparent by the entire disclosure of the present disclosure including the claims.

The electronic device according to the present disclosure is suitably applicable to a portable electronic device having a risk of getting wet. Examples of the electronic device to which the present disclosure is applicable may include mobile phones, portable audio players, portable game machines, laptop computers, cameras, video cameras, and electronic dictionary.

### REFERENCE SIGNS LIST

11 Main body
12 Cover
12a Through hole
13 Housing
20 Fixing mechanism
21 Rotating knob
22a, 22b Protruding portion
23a, 23b Recess portion
24a, 24b Engaging portion
31a, 31b Groove portion
32a, 32b Drain portion
33 Contact portion
35 Water stop portion
36 Packing
41 Protected portion
100 Electronic device

1. An electronic device, comprising:
a main body having a portion to be protected;
a cover having a through hole and covering at least part of the main body;
a fixing mechanism fixing the cover to the main body; and
a waterproof mechanism draining water to the outside, said waterproof mechanism being provided outside said portion to be protected, the water having entered into a gap between the cover and the main body;
wherein the fixing mechanism comprises:
a rotating knob provided in the main body and inserted into the through hole when the cover is fixed to the main body;
a protruding portion moved by rotation of the rotating knob;
an engaging portion provided inside the cover and engaging with the protruding portion when the cover is fixed to the main body; and
a recess portion provided in the main body and accommodating the engaging portion when the cover is fixed to the main body; and
wherein the waterproof mechanism comprises a groove portion provided in the main body or the cover, extending toward an outer edge of the cover, and coming into communication with the recess portion when the cover is fixed to the main body.

2. The electronic device according to claim 1;
wherein the main body further comprises a protected portion exposed from the main body when the cover is detached;
wherein the waterproof mechanism further comprises a water stop portion that is provided between the cover and the main body and prevents water from entering into the protected portion when the cover is fixed to the main body; and
wherein the groove portion is formed close to the water stop portion with respect to the rotating knob.

3. The electronic device according to claim 2;
wherein the groove portion extends along part of the water stop portion.

4. The electronic device according to claim 1;
wherein the recess portion further accommodates the protruding portion disengaged from the engaging portion when the rotating knob is rotated to detach the cover from the main body.

5. The electronic device according to claim 1;
wherein part of the water that has entered into the gap between the cover and the main body is drained to the outside through the groove portion by shaking the electronic device by an operator.
